(19) United States
(12) Patent Application Publication
(10) Pub. No.: US 2004/0003307 A1
(43) Pub. Date: Jan. 1, 2004

(54) Information processing apparatus and power supply control method

(75) Inventor: Hiroyuki Tsuji, Ome-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/461,501

(22) Filed: Jun. 16, 2003

(30) Foreign Application Priority Data
Jun. 28, 2002 (JP) 2002-190899

(51) Int. Cl. G06F 1/26

(52) U.S. Cl. 713/310

(57) ABSTRACT

An information processing apparatus comprising a first communication device configured to receive an external signal, a second communication device configured to receive an external signal different from the external signal received by the first communication device, power supply part which selectively supplies power to one of the first communication device and the second communication device in a power-supply-off state, and a part which activates the information processing apparatus based on the signal received by one of the first communication device and the second communication device to which power is supplied from the part which activates the information processing apparatus.

### CROSS-REFERENCE TO RELATED APPLICATIONS

This application is based upon and claims the benefit of priority from the prior Japanese Patent Application No. 2002-190899, filed Jun. 28, 2002, the entire contents of which are incorporated herein by reference.

### BACKGROUND OF THE INVENTION

1. Field of the Invention

This invention relates to an information processing apparatus which is suitable to a PDA, a hand-held type personal computer and the like, and a power supply control method.

2. Description of the Related Art

In recent years, easily portable information processing apparatuses such as PDA (personal digital assistant) and hand-held type personal computer have become increasingly popular.

Many such information processing apparatuses which incorporate wireless communication means become widely available due to the development of wireless communication technologies. In addition, apparatuses which can be conveniently connected to communication networks become also widely available.

The wireless communication means includes wireless communication methods based on Bluetooth™ and the IEEE 802.11 Standard, and wireless communication is realized by incorporating the wireless communication means in the information processing apparatus.

Card devices having wireless communication functions have also been developed in recent years. Therefore, even in a case that the information processing apparatus does not incorporate such wireless communication means, wireless communication can be performed easily by inserting the wireless card device is into a predetermined card slot provided to the information processing apparatus.

Some information processing apparatus having wireless communication functions are also provided with a wakeup technique. In other words, they are adapted to receive an external signal by way of wireless communication means when the power supply of the information processing apparatus is turned off and the received signal is used as trigger for activating the information processing apparatus.

To realize the wakeup technique, the power supply to the wireless communication card inserted into the card slot must be kept even when the power supply is turned off. Therefore, the power of the power supply is wasted in the mobile information processing device using a battery whose capacity is limited.

Some information processing apparatuses are adapted to address this problem by allowing the user to select either use or non-use of the wakeup technique. If use of the wakeup technique is selected, the apparatus is ready for wakeup operations although power may be consumed to some extent. If, on the other hand, non-use of the wakeup technique is selected, power will not be consumed at all so long as the power supply of the apparatus is off.

However, with such an arrangement, the user is forced to select only either use or non-use of the wakeup technique if his or her information processing apparatus is provided with a plurality of communication devices including wireless communication cards that are adapted to wakeup operations. In other words, known information processing apparatus of the type under consideration are not designed to elaborately define the tradeoff of power consumption and wakeup operations.

### BRIEF SUMMARY OF THE INVENTION

An information processing apparatus according to a first aspect of the invention comprises: a first communication device configured to receive an external signal; a second communication device configured to receive an external signal different from the external signal received by the first communication device; means for selectively supplying power to one of the first communication device and the second communication device in a power-supply-off state; and means for activating the information processing apparatus based on the signal received by one of the first communication device and the second communication device to which power is supplied from the means for activating the information processing apparatus.

A power supply control method of an information processing apparatus, which comprises a first communication device configured to receive an external signal and a second communication device configured to receive an external signal different from the external signal received by the first communication device, according to a second aspect of the invention comprises: selectively supplying power to one of the first communication device and the second communication device in a power-supply-off state of the information processing apparatus; and activating the information processing apparatus based on the signal received by way of one of the first communication device and the second communication device to which power is selectively supplied.

A power supply control method according to a third aspect of the invention of an information processing apparatus, which comprises a first communication device configured to receive an external signal and a second communication device configured to receive an external signal different from the external signal received by the first communication device, at least one of the communication devices being removably fitted to the information processing apparatus, comprises: selectively supplying power to one of the first communication device and the second communication device in a power-supply-off state of the information processing apparatus; activating the information processing apparatus based on the signal received by way of one of the first communication device and the second communication device to which power is selectively supplied; stopping the power supply to one of the first communication device and the second communication device to which power is supplied at detection of the removal thereof from the information processing apparatus; starting supplying power to one of the second communication device and the first communication device to which power has not been supplied in place of the communication device whose power supply ahs been stopped; and restarting supplying power to the fitted communication device and stopping the power supply to the communication device to which power has been supplied, when the removed device is refitted to the information processing apparatus.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serves to explain the principles of the invention.

FIG. 1 shows the external configuration of a personal computer according to an embodiment of the present invention;

FIG. 2 is a block diagram showing a part of the circuit in the personal computer according to the embodiment;

FIG. 3 is a flow chart showing the processing operation according to the embodiment when the wakeup technique is selected;

FIG. 4 is a flow chart showing the processing operation at the wakeup operation according to the embodiment; and

FIG. 5 is a block diagram showing a part of another circuit in the personal computer according to the embodiment.

### DETAILED DESCRIPTION OF THE INVENTION

Now, the embodiment of the present invention will be described with reference to the accompanying drawings in a case that the embodiment of the present invention is applied to the notebook-type personal computer.

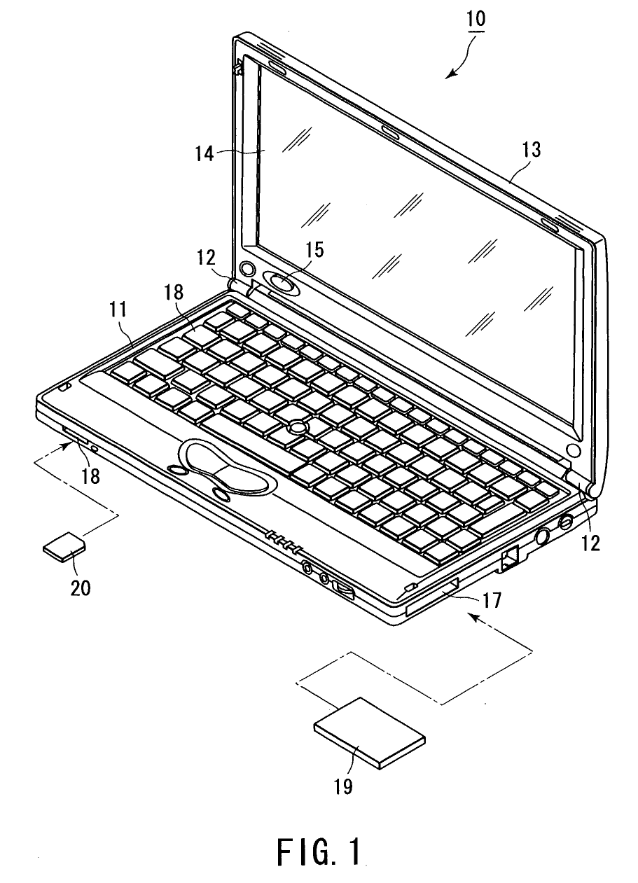

FIG. 1 is a schematic perspective view of the personal computer (PC) 10. As shown in FIG. 1, a display section 13 that also operates as cover is linked to main body case 11 by means of hinge mechanisms 12, 12 so as to make the personal computer 10 foldable.

The display section 13 includes a color liquid crystal panel 14 having a backlight and a power switch 15 at the inner surface side thereof.

The main body case 11 has a keyboard 16, which includes a pointing device, arranged on the top side thereof, a PC card slot 17, which is based on the PCMCIA Standard, arranged at the right side thereof and an SD (secure digital) card slot 18 arranged at the left end of the front side thereof.

A wireless LAN card 19 based on the IEEE 802.11 Standard is removably fitted to the PC card slot 17 as a communication device for receiving a wakeup signal.

On the other hand, a Bluetooth card 20 adapted to transmit data to and receive data from an external device according to the Bluetooth Standard is removably fitted to the SD card slot 18 as a communication device for receiving a wakeup signal.

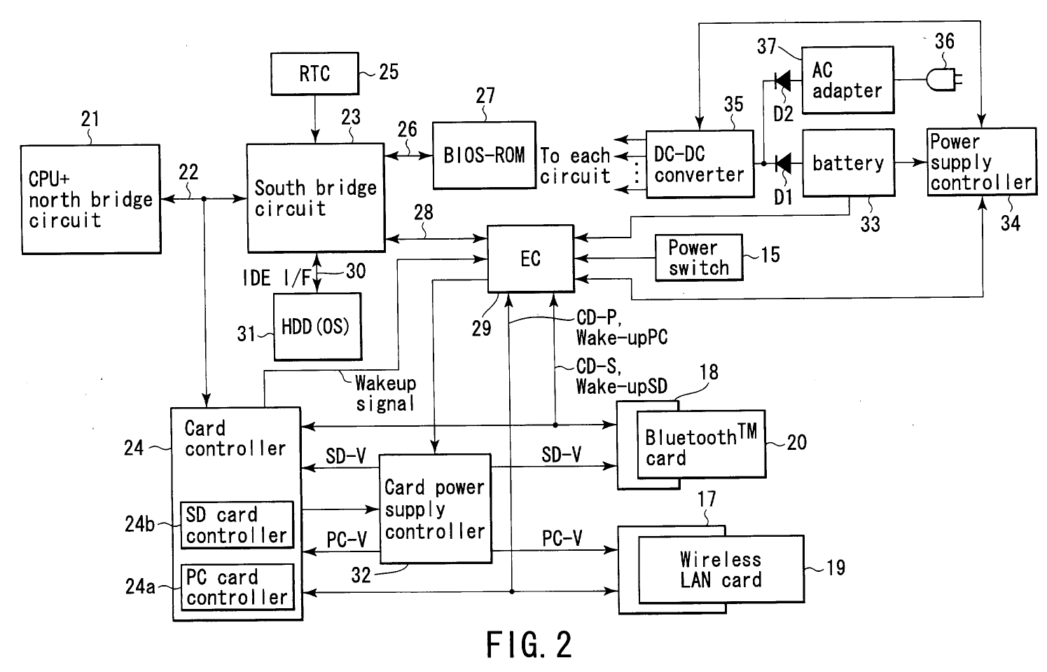

FIG. 2 shows a part of the circuit in the personal computer 10.

Referring to FIG. 2, a CPU and north bridge circuit 21 processes various data when the power supply of the personal computer 10 is on.

A south bridge circuit 23 and card controller 24 are connected to the CPU+north bridge circuit 21 by way of a PCI (peripheral component interconnect) bus 22.

The south bridge circuit 23 is a controller which performs data conversion, traffic control and other operations between the PCI bus 22 and ISA bus 26.

The south bridge circuit 23 is connected to RTC (real time clock) 25. Additionally, the south bridge circuit 23 is connected to a BIOS-ROM 27 by way of the ISA (industry standard architecture) bus 26, to an EC (embedded controller) 29 by way of a serial bus 28 and an HDD (hard disk drive) 31 by way of an IDE interface (I/F) 30.

The RTC 25 keeps time of the current clock time regardless of the power supply is in an on or off state.

The BIOS-ROM 27 is a ROM securely storing the BIOS (basic input/output system).

The HDD 31 stores an OS (operating system), various application programs and data files, etc.

The card controller 24 controls the operation of exchanging data between the cards fitted respectively to the PC card slot 17 and the SD card slot 18 and the CPU+north bridge circuit 21 and the south bridge circuit 23 by way of the PCI bus 22. The card controller 24 includes a PC card controller 24a and an SD card controller 24b.

A signal line connecting the card controller 24 and the PC card slot 17 is also connected to the EC 29. When the wireless LAN card 19 is fitted to or removed from the PC card slot 17, the card detection signal CD-P output from the card controller 24 and the wakeup signal detected by the wireless LAN card 19 are transmitted to the EC 29.

Similarly, the signal line connecting the card controller 24 and the SD card slot 18 is also connected to the EC 29. As the Bluetooth card 20 is fitted to or removed from the SD card slot 18, the card detection signal CD-S output from the card controller 24 and the wakeup signal detected by the Bluetooth card 20 are transmitted to the EC 29.

The EC 29 receives wakeup signals from the card controller 24 and is connected to card power supply controller 32, power supply switch 15, battery 33 and power supply controller 34.

The card power supply controller 32 supplies driving power supply PC-V for driving the wireless LAN card 19 to the PC card slot 17 and to the PC card controller 24a of the card controller 24 in response to the signal given from the EC 29 and the control signal from the card controller 24. On the other hand, the card power supply controller 32 supplies driving power supply SD-V for driving the Bluetooth card 20 to the SD card slot 18 and the SD card controller 24b of the card controller 24.

The battery 33 is one of the power supplies of the personal computer 10. Typically, a rechargeable type battery such as lithium ion type battery is used. The battery 33 supplies the power to a DC-DC converter 35 by way of a diode D1 and also to the power supply controller 34.

When an AC plug 36 for AC driving the personal computer 10 is connected to an AC plug socket (not shown), AC power supplied through the AC plug 36 is rectified and stepped down by the AC adapter 37 and is supplied to the DC-DC converter 35 by way of the diode D2.

The DC-DC converter 35 converts the supplied power into several predetermined voltages and supplies them respectively to a number of circuits including the card power supply controller 32 under the control of the power supply controller 34.

The diodes D1, D2 are provided in order to prevent the electric currents from the battery 33 and the AC adapter 37 from running into the other circuits.

The power supply controller 34 monitors the voltage condition of the battery 33 and controls the operation of the DC-DC converter 35. At the same time, the power supply controller 34 reports the voltage condition of the battery 33 to the EC 29.

Operation of the above-described embodiment will be explained.

Assume that the wireless LAN card 19 and the Bluetooth card 20 are fitted respectively into the PC card slot 17 and the SD card slot 18 in advance in the embodiment.

As the wireless LAN card 19 and the Bluetooth card 20 are fitted into the respective slots, the EC 29 reads and holds the identification information specific to each of the cards, for example, tuple information by way of the card controller 24.

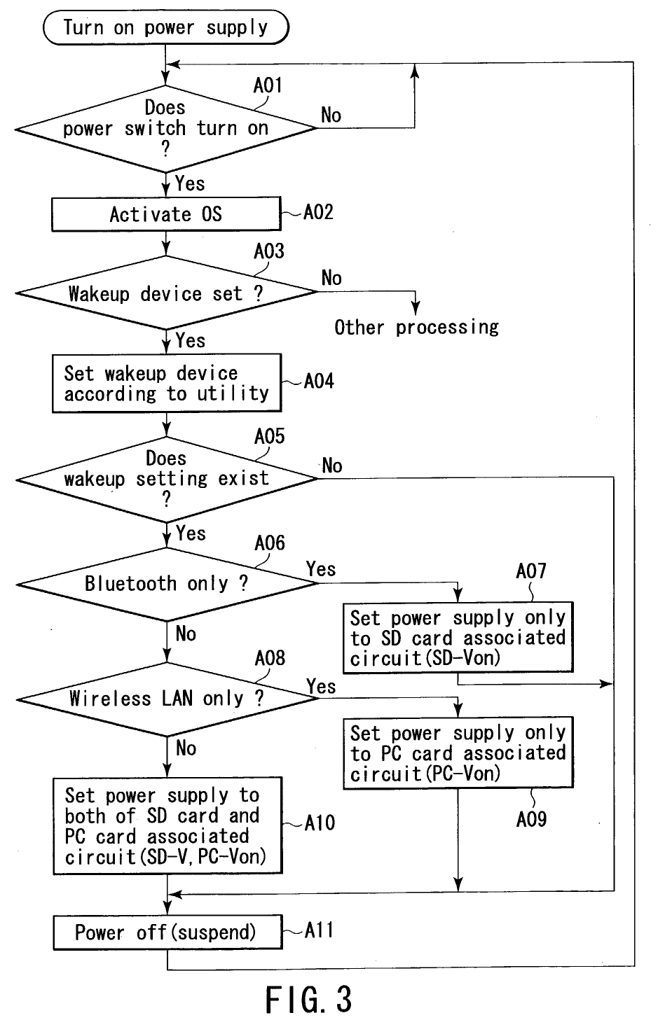

FIG. 3 shows the processing operation, from the time when the power supply is turned on by operating the power supply switch 15 to the time when the wireless LAN card 19 and the Bluetooth card 20 are selected as communication devices adapted to receive a wakeup signal if the power supply is turned off.

In this embodiment, the EC 29 mainly performs the processing operation.

Firstly, when the power supply is in an off state, the EC 29 judges repeatedly if the power supply switch 15 is operated or not and waits for the time when the power supply switch 15 is operated (Step A01).

As the power supply switch 15 is operated, the EC 29 detects the operation thereof and starts to activate the OS stored in the HDD 31 by the south bridge circuit 23 (Step A02).

In the process of starting to activate the OS, the EC 29 temporarily supplies the PC card controller 24a of the card controller 24 and the wireless LAN card 19 with power supply PC-V and, at the same time, the SD card controller 24b of the card controller 24 and the Bluetooth card 20 with power supply SD-V by means of the card power supply controller 32.

During the various preparatory operations of the OS, it is determined if the wireless LAN card 19 and/or the Bluetooth card 20 are selected as communication devices for receiving a wakeup signal or not (Step A03). If neither of them is selected, the EC 29 enters some other processing operation.

If, on the other hand, the wireless LAN card 19 and/or the Bluetooth card 20 are selected as communication devices for receiving a wakeup signal in Step A03, the wireless LAN card 19 and/or the Bluetooth card 20 are defined to operate as wakeup devices based on various utility settings (Step A04). Subsequently, it is determined if wakeup is defined for the wireless LAN card 19 and/or the Bluetooth card 20 or not (Step A05). When the wakeup is defined, it is determined if at least one of the wireless LAN card 19 fitted to the PC card slot 17 and the Bluetooth card 20 fitted to the SD card slot 18 is selected to operate as wakeup device or not.

If it is determined that at least one of them is selected, it is determined if only the Bluetooth card 20 fitted to the SD card slot 18 is selected as communication device for receiving a wakeup signal or not (Step A06).

If it is determined that only the Bluetooth card 20 is selected as communication device for receiving a wakeup signal, power is supplied only to the circuits associated with the Bluetooth card 20. More specifically, only the power supply SD-V is activated and power supply SD-V is supplied only to the SD card controller 24b of the card controller 24 and the Bluetooth card 20 by means of the card power supply controller 32. On the other hand, the power supply PC-V is deactivated so that no power supply PC-V is supplied to the PC card controller 24a of the card controller 24 and the wireless LAN card 19 (Step A07).

If, on the other hand, it is determined in Step A06 that it is not only the Bluetooth card 20 which is selected to operate as communication device for receiving a wakeup signal, it is determined if only the wireless LAN card 19 fitted to the PC card slot 17 is selected as communication device for receiving a wakeup signal or not (Step A08).

If it is determined that only the wireless LAN card 19 is selected as communication device for receiving a wakeup signal, power is supplied only to the circuits associated with the wireless LAN card 19. More specifically, only the power supply PC-V is activated and power supply PC-V is supplied only to the PC card controller 24a of the card controller 24 and the wireless LAN card 19 by means of the card power supply controller 32. On the other hand, the power supply SD-V is deactivated so that no power supply SD-V is supplied to the SD card controller 24b of the card controller 24 and the Bluetooth card 20 (Step A09).

Furthermore, if it is determined in Step A08 that it is not only the wireless LAN card 19 which is selected to operate as communication device for receiving a wakeup signal, both of the wireless LAN card 19 and the Bluetooth card 20 are selected to operate as communication devices for receiving a wakeup signal. Therefore, power is supplied to the circuits associated with the wireless LAN card 19 and also to the circuits associated with the Bluetooth card 20. More specifically, the power supply PC-V is activated and power supply PC-V is supplied to the PC card controller 24a of the card controller 24 and the wireless LAN card 19 by means of the card power supply controller 32. At the same time, the power supply SD-V is activated and power supply SD-V is supplied only to the SD card controller 24b of the card controller 24 and the Bluetooth card 20 also by means of the card power supply controller 32 (Step A10).

If it is determined in Step A04 that the wireless LAN card 19 and/or the Bluetooth card 20 are selected as communication devices for receiving a wakeup signal but it is determined in Step A05 that neither of them is selected as wakeup device for receiving a wakeup signal, none of the processing operations of the above Steps A07, A09 and A10 will be executed.

The power supply is turned off and held to a suspended state (Step A11) when it is determined in Step A05 that neither of the cards is selected to operate as communication device for receiving a wakeup signal or after the processing operations of Steps A07, A09 and A10. The processing operation based on the selection of communication devices for receiving a wakeup signal is once ended through the above described steps, the operation enters the standby state of the wakeup signal.

As pointed out above, if it is determined in Step A05 that neither of the cards is selected to operate as communication device for receiving a wakeup signal, none of the processing operations of the above Steps A07, A09 and A10 will be executed. Therefore, when the power supply is held to a suspended state, both the power supply PC-V to the PC card controller 24a of the card controller 24 and the wireless LAN card 19 and the power supply SD-V to the SD card controller 24b of the card controller 24 and the Bluetooth card 20 by the card power supply controller 32 are stopped.

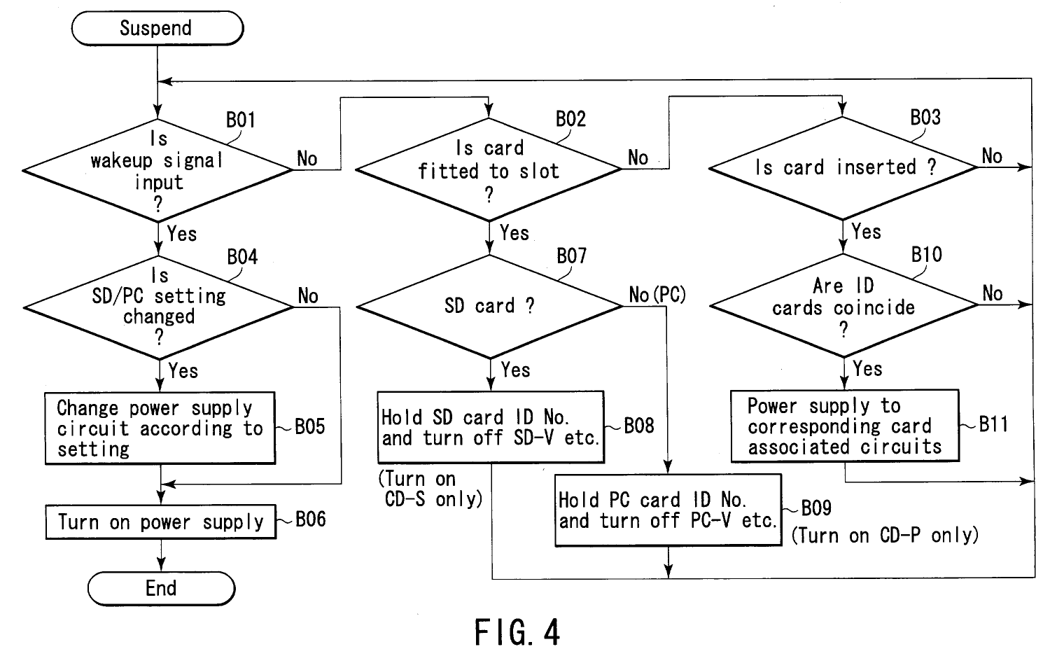

The processing operation that is mainly performed by the EC 29 for waiting for a wakeup operation in a suspended state will be described with reference to FIG. 4.

In a suspended state, it is determined if a wakeup signal is input from the wireless LAN card 19 or the Bluetooth card 20 or not (Step B01).

If no wakeup signal is input, it is determined if a card detection signal CD-P or CD-S, which indicates that the wireless LAN card 19 is fitted into the PC card slot 17 or the Bluetooth card 20 is fitted into the SD card slot 18, is output from the card controller 24 or not (Step B02).

If no such card detection signal is detected, it is determined if there is a card detection signal CD-P or CD-S output from the card controller 24 as a result of an action that a new wireless LAN card 19 is fitted into the PC card slot 17 or a new Bluetooth card 20 is fitted into the SD card slot 18 or not (Step B03).

Thus, reception of a wakeup signal and fitting or removing a wireless LAN card 19 or a Bluetooth card 20 are monitored by repeatedly executing the determining steps B01 through B03.

If it is determined in Step B01 that the wakeup signal is input from the wireless LAN card 19 or the Bluetooth card 20, the EC 29 determines if the selection of the wireless LAN card 19 is changed to the Bluetooth card 20 or vice versa or not based on the input wakeup signal (Step B04).

Only if it is determined that such a change is set, the power supply SD-V to the SD card controller 24b and the Bluetooth card 20 is turned on in place of the power supply PC-V from the card power supply controller 32 provided that the wakeup signal is from the wireless LAN card 19.

Contrary, when the wakeup signal is from the Bluetooth card 20, the power supply PC-V to the PC card controller 24a and the wireless LAN card 19 is turned on in place of the power supply SD-V from the card power supply controller 32.

Thereafter, the power-supply-on state is restored from the suspended state by the resume function (Step B06) and, at this time, an operation of data communication with a nearby external communication device is started by the communication device to which power is supplied and which is adapted to receive a wakeup signal.

The processing operation in Step B04 or B05 is for controlling the suitable data communication system in a standby state waiting for a wakeup signal or in data communication state under a mobile computing environment, whichever appropriate.

More specifically, in a suspended state, the Bluetooth card 20 that consumes standby power only at a low rate is made to perform a standby operation waiting for a wakeup signal. If the personal computer 10 is moved to a location where it can conducts wireless communication with an external device, the wireless LAN card 19 is selected and used for wireless communication because it is far advantageous in terms of data transfer rate, although it consumes standby power at a rate that is incomparably higher than the power consumption rate of the Bluetooth card 20.

If it is determined in Step B02 that a card detection signal CD-P or CD-S is output from the card controller 24, it is then determined that the detection signal is CD-S or not (Step B07).

If it is determined that the detection signal is CD-S, it means that the Bluetooth card 20 is removed. Therefore, the identification information of the Bluetooth card 20 which has been fitted is held and the power supply SD-V from the card power supply controller 32 to the SD card controller 24b and the Bluetooth card 20 is turned off to stop the power supply (Step B08). Then, the standby state from Step B01 is resumed.

At this time, as shown in ( ) of FIG. 4, it may be arranged that the power supply PC-V from the card power supply controller 32 to the PC card controller 24a and the wireless LAN card 19 is newly turned on to start the power supply so as to enter a standby state of waiting for a wakeup operation by a different wireless communication system.

If it is determined in Step B07 that the card detection signal output from the card controller 24 is not CD-S, it means that the detection signal is CD-P and the wireless LAN card 19 is removed from the PC card slot 17. Therefore, the EC 29 holds the identification information of the wireless LAN card 19 which has been fitted to the card slot.

Thereafter, the EC 29 turns off the power supply PC-V from the card power supply controller 32 to the PC card controller 24a and the wireless LAN card 19 to stop the power supply (Step B09) and then the standby state from Step B01 is resumed.

At this time, as shown in ( ) of FIG. 4, it may be arranged that the power supply SD-V from the card power supply controller 32 to the SD card controller 24b and the Bluetooth card 20 is newly turned on to start the power supply so as to enter a standby state of waiting for a wakeup operation by a different wireless communication system.

If it is determined in Step B03 that there is a card detection signal CD-P or CD-S because a wireless LAN card 19 is newly fitted into the PC card slot 17 or a Bluetooth card 20 is newly fitted into the SD card slot 18, it is then determined if the card that has been removed is newly fitted into the slot or not by determining if the identification information of the newly fitted card 19 or 20 agrees with the identification information of the card which was fitted in the card slot 17 or 18 (Step B10).

Only if the two pieces of identification information agree with each other, power supply PC-V or SD-V is supplied from the card power supply controller 32 to the PC card controller 24a and the wireless LAN card 19 or to the SD card controller 24b and the Bluetooth card 20, because the card that has been removed is fitted into the corresponding slot once again (Step B11). Thereafter, the standby state from Step B01 is resumed.

Thus, when a plurality of communication devices such as a wireless LAN card 19 and a Bluetooth card 20 are provided, power is supplied in a power off state, or a suspended state, only to the card which is selected for a wakeup operation. With this arrangement, it is possible to wait for a wakeup operation, while minimizing the power consumption.

Additionally, since the wireless LAN card 19 and the Bluetooth card 20 can be respectively removably fitted into the PC card slot 17 and the SD card slot 18, it is possible to remove the wireless LAN card 19 and the Bluetooth card 20 while waiting for a wakeup operation.

Therefore, if the communication device in question, which is the wireless LAN card 19 or the Bluetooth card 20, is removed, the removal is detected immediately and the power supply to the card is stopped immediately. Waste of power is effectively avoided with this arrangement.

As described above for Step B08 or B09, the standby state waiting for a wakeup operation can be maintained by supplying power to the other communication device that remains in the corresponding slot.

If the communication devices of the wireless LAN card 19 or the Bluetooth card 20 is removed and a card is newly fitted into the slot, it is possible to recognize if a right communication device is fitted into the slot or not by determining if the identification information of the removed card and that of the newly fitted communication device agree with each other or not because the identification information of the wireless LAN card 19 and that of the Bluetooth card 20 are held.

Thus, if the communication device that has been removed from the corresponding slot is refitted into the slot, the sameness is recognized and power is supplied to the device so that the standby state waiting for a wakeup operation is resumed.

If the power supply system for continuing the standby state waiting for a wakeup operation is switched to another system as indicated in Step B08 or B09, the power supply by the another power supply system is stopped and the power supply by the original power supply system is resumed to continue the standby state waiting for a wakeup operation in order to avoid waste of power when the communication device is fitted back into the slot.

The RTC 25 which times the current clock time is connected to the south bridge circuit 23 regardless if the power supply is on or off. Therefore, if the time zone in which a wakeup operation will take place is defined and information on the defined time zone is stored in the EC 29 in advance, it is possible to supply power from the card power supply controller 32 to the wireless LAN card 19 and the associated devices or to the Bluetooth card 20 and the associated devices only during the defined time zone under the control of the EC 29 with reference to the current time shown by the RTC 25 which is connected to the south bridge circuit 23.

With this arrangement, the power supply to the communication devices is stopped during the time zone in which it is not necessary to keep the standby state waiting for a wakeup signal so that waste of power can be avoided reliably in that time zone.

In the above described embodiment, the power supply is turned off to automatically get into a suspended state of maintaining the operating conditions of the operating system and the application programs after setting a wakeup operation as shown in FIG. 3.

As the power supply is turned off in the suspended state, the operating system and the application programs are started quickly to activate any selected application program when the power supply is turned on subsequently by a wakeup operation if compared with an arrangement of completely ending the operations of the operating system and the application programs and the power supply is terminated.

(Modification to the Embodiment)

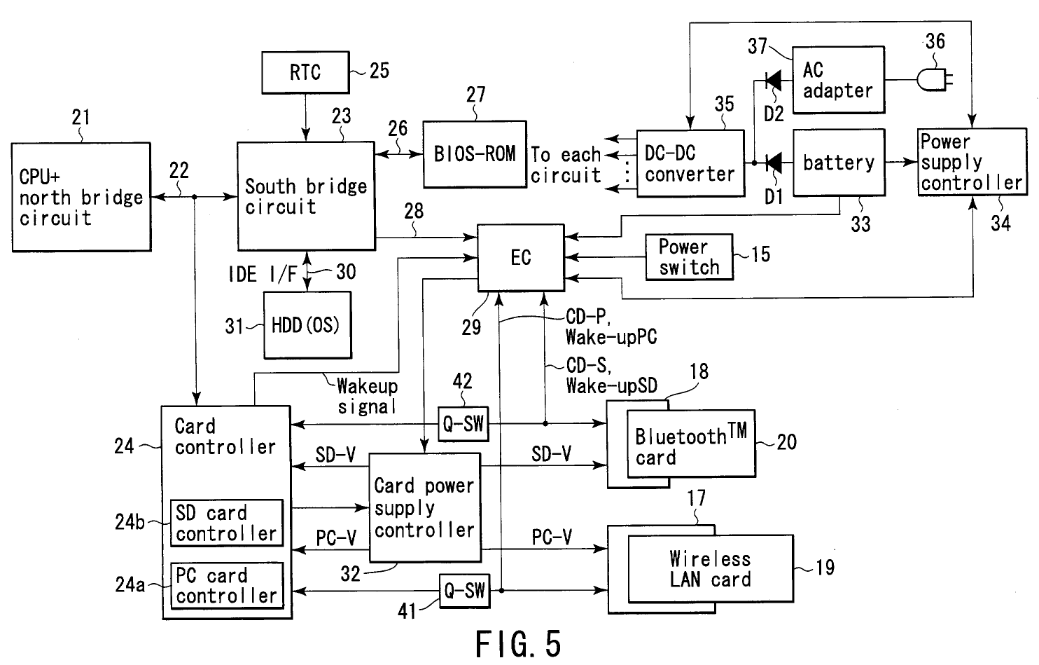

FIG. 5 shows a part of the circuit of another personal computer 10 which differs from that of FIG. 2.

The personal computer 10 shown in FIG. 5 is basically the same as that of FIG. 2. Therefore, the components that are the same as those of FIG. 2 are denoted respectively by the same reference symbols and will not be described any further.

In FIG. 5, an interface connecting/disconnecting Q (quick) switch 41 (denoted by “Q-SW” in FIG. 5) is arranged between the card controller 24 and the PC card slot 17 for switching from allowing data to pass through to blocking data from passing through and vice versa.

Similarly, an interface connecting/disconnecting Q-switch 42 is arranged between the card controller 24 and the SD card slot 18 for switching from allowing data to pass through to blocking data from passing through and vice versa.

Each of the Q-switches 41, 42 is switched to block data from passing through unless the wireless LAN card 19 or the Bluetooth card 20 is used for a standby state waiting for a wakeup operation.

With this arrangement, it is possible to reliably avoid power being supplied from the card controller 24 to either the wireless LAN card 19 or the Bluetooth card 20 from being supplied to the other communication device so that waste of power is securely eliminated.

The above embodiment is exemplified to a personal computer 10 in which a wireless LAN card 19 is fitted into the PC card slot 17 and a Bluetooth card 20 is fitted into the SD card slot 18, but the present invention is not limited to the above embodiment. The present invention is applicable to any portable registered terminal of a PDA or POS (point of sales) system in which the portable information apparatus comprises a plurality of devices capable of a wakeup operation such as wired LAN interface.

In the above embodiment, communication devices which are removably fitted to corresponding respective slots are described, but the present invention is not limited to the above described embodiment. In other words, the present invention is applicable to a plurality of any internal communication devices.

Additionally, the present invention is not limited to the above described embodiment, which may be modified or altered in various different ways within the scope of the invention.

Furthermore, the above described embodiment contains various stages of invention so that various inventions may be drawn by appropriately combining a plurality of disclosed components. For example, if at least one of the objects of the present invention as pointed out earlier is achieved and at least one of the advantages as pointed out above is obtained even when a number of components are deleted from the entire components of the embodiment, the arrangement obtained by deleting those components can be drawn as invention.

Thus, the above described embodiment of the invention comprises a plurality of communication devices adapted to receive a wakeup signal and can be held in a standby state for receiving a wakeup signal, while avoiding waste of power, because power is supplied only to one of the communication devices selected to operate for receiving a wakeup signal when the power supply of the main body is turned off.

Additional advantages and modifications will readily occur to those skilled in the art. Therefore, the present invention in its broader aspects is not limited to the specific details, representative devices and illustrated examples shown and described herein. Accordingly, various modifications may be made without departing from the spirit or scope of the general inventive concept as defined by the appended claims and their equivalents.

What is claimed is:

1. An information processing apparatus comprising:
a first communication device configured to receive an external signal;
a second communication device configured to receive an external signal different from the external signal received by the first communication device;
means for supplying power to one of the first communication device and the second communication device in a power-supply-off state; and
means for activating the information processing apparatus based on the signal received by one of the first communication device and the second communication device to which power is supplied from the means for activating the information processing apparatus.

2. The apparatus according to claim 1, wherein
one of first communication device and the second communication device is removably fitted to the information processing apparatus, and
the means for supplying stops the power supply to the removed communication device, when one of the first communication device and the second communication device to which power is supplied is removed from the information processing apparatus.

3. The apparatus according to claim 2, wherein the means for activating the information processing apparatus starts supplying power to the communication device to which power has not been supplied, when one of the first communication device and the second communication device to which power is supplied is detected to be removed from the information processing apparatus.

4. The apparatus according to claim 3, wherein the means for activating the information processing apparatus restarts supplying power to the refitted communication device and stops the power supply to the communication device to which power has been supplied, when the removed communication device is fitted again to the information processing apparatus.

5. The apparatus according to claim 2, further comprising means for storing identification information of the communication device to which power is supplied from the means for activating the information processing apparatus in a power-supply-off state of the apparatus; wherein,
the means for activating the information processing apparatus starts supplying power to the fitted communication device, when one of the first communication device and the second communication device is fitted to the information processing apparatus and the identification information stored in the means for storing identification information of the communication device and the identification information of the fitted communication device agree with each other.

6. The apparatus according to claim 2, further comprising:
means for storing identification information of the communication device to which power is supplied from the means for supplying in a power-supply-off state of the apparatus; wherein,
the means for activating the information processing apparatus starts supplying power to the fitted communication device and stops the power supply to the communication device to which power has been supplied, when one of the first communication device and the second communication device is fitted to the information processing apparatus and the identification information stored in the means for storing identification information of the communication device and the identification information of the fitted communication device agree with each other.

7. The apparatus according to claim 1, further comprising:
a clock; and
a memory which stores a predetermined time zone, wherein
the means for activating the information processing apparatus also stops the power supply to one of the first communication device and the second communication device to which power has been supplied in a power-supply-off state of the information processing apparatus based on the current clock time indicated by the clock and the information on the predetermined time zone stored in the memory.

8. The apparatus according to claim 1, further comprising:
means for holding the operating system and the application program in a memory device and making the apparatus enter a power-supply-off state; and
means for selectively supplying power to one of the first communication device and the second communication device in the power-supply-off state of the apparatus entered by the means for holding the operating system and the application program and activating the information processing apparatus based on the signal received by way of one of the first communication device and the second communication device to which power is supplied.

9. A power supply control method of an information processing apparatus comprising a first communication device configured to receive an external signal and a second communication device configured to receive an external signal different from the external signal received by the first communication device, the method comprising:
selectively supplying power to one of the first communication device and the second communication device in a power-supply-off state of the information processing apparatus; and
activating the information processing apparatus based on the signal received by way of one of the first communication device and the second communication device to which power is selectively supplied.

10. A power supply control method of an information processing apparatus comprising a first communication device configured to receive an external signal and a second communication device configured to receive an external signal different from the external signal received by the first communication device, at least one of the communication devices being removably fitted to the information processing apparatus, the method comprising:
selectively supplying power to one of the first communication device and the second communication device in a power-supply-off state of the information processing apparatus;
activating the information processing apparatus based on the signal received by way of one of the first communication device and the second communication device to which power is selectively supplied;
stopping the power supply to one of the first communication device and the second communication device to which power is supplied at detection of the removal thereof from the information processing apparatus;
starting supplying power to one of the second communication device and the first communication device to which power has not been supplied in place of the communication device whose power supply ahs been stopped; and
restarting supplying power to the fitted communication device and stopping the power supply to the communication device to which power has been supplied, when the removed device is refitted to the information processing apparatus.

11. The method according to claim 10, further comprising: storing the identification information of the communication device to which power is supplied in a power-supply-off state of the information processing apparatus; wherein
the stopping of power supply includes starting supplying power to the fitted communication device to the information processing apparatus only when one of the first communication device and the second communication device is fitted to the information processing apparatus and the stored identification information and the identification information of the fitted communication device agree with each other.
